(19) United States
(12) Patent Application Publication
(10) Pub. No.: US 2019/0087859 A1
(43) Pub. Date: Mar. 21, 2019

(54) SYSTEMS AND METHODS FOR FACILITATING DEALS

(71) Applicant: Node Inc., San Francisco, CA (US)

(72) Inventor: Falon Fatemi, San Francisco, CA (US)

(21) Appl. No.: 16/134,357

(22) Filed: Sep. 18, 2018

Related U.S. Application Data
(63) Continuation of application No. 14/748,140, filed on Jun. 23, 2015.
(60) Provisional application No. 62/016,015, filed on Jun. 23, 2014.

(51) Int. Cl. G06Q 30/02; G06Q 50/00

(52) U.S. Cl. CPC G06Q 30/0255; G06Q 50/01

(57) ABSTRACT

Systems and methods for facilitating deals are provided. A method for facilitating a deal comprises providing one or more search criteria of a user directed to deals over potential business opportunities. The one or more search criteria include textual, graphical and/or audio information that are indicative of one or more industry segments of interest to the user. Next, using a computer processor that is programmed to identify deals of interest to users, a search of a repository of deals directed to the one or more search criteria is conducted to identify one or more deals of interest to the user, which search is conducted without any involvement from the user. Next, the one or more identified deals are presented to the user on a user interface of an electronic device of the user.

### CROSS-REFERENCE

This application claims priority to U.S. Provisional Patent Application Ser. No. 62/016,015, filed Jun. 23, 2014, which is entirely incorporated herein by reference.

### BACKGROUND

Individuals and entities (e.g., companies) routinely look to engage in deals. Examples of deals include business opportunities, such as company financing opportunities and mergers and acquisitions. For instance, emerging or early stage companies routinely seek financial capital for growth. Without financial capital, growth for early stage companies (startups) may be difficult.

There are various types of financial capital that companies, including early stage companies, may seek. Financial capital may be provided by investors, such as angel investors and venture capital firms. A venture capital fund typically earns money by owning equity in the companies it invests in. Typical venture capital investment occurs after the seed funding round as the first round of institutional capital to fund growth in the interest of generating a return through an eventual realization event, such as an initial public offering (IPO) or sale of the company.

A company may also seek investment from an angel investor or seed money. An angel investor or angel is an individual who provides capital for a business start-up, usually in exchange for convertible debt or ownership equity. Seed money may be a form of securities offering in which an investor purchases part of a business. A seed fund may be a relatively early investment and in some cases meant to support the business until it can generate cash of its own, or until it is ready for further investments.

### SUMMARY

Individuals and companies routinely engage in deals over business opportunities. Emerging companies engage in deals with investors for funding. However, recognized herein are various issues associated with the manner in which individuals conduct deals in the context company transactions, such as funding emerging companies or purchasing companies. One issue is that companies in need of financial backing are routinely unable to reach their optimum target audience, including potential investors. This can be problematic because such companies can spend lots of time and resources to propose their business model to potential investors that may not be the audience most likely to fund the companies. Another issue is that investors routinely hear business proposals from companies that they may not be interested. Thus, there are considerable inefficiencies on both the side of companies seeking investment and investors seeking to invest in companies.

The present disclosure provides systems and methods that facilitate deal making. In some cases, systems and methods of the present disclosure can advantageously aid in improving the manner in which companies or individuals seeking investment are connected with companies or individuals that may be interested in investing in such companies.

An aspect of the present disclosure provides a method for facilitating deals, comprising accessing one or more network sources of a user and identifying content in the one or more network sources, which content comprises textual, graphical and/or audio information. Next, using a computer processor that is programmed to identify industry segments, user interests and/or roles from content, the content can be searched for textual, graphical and/or audio information that are indicative of one or more industry segments, user interests and/or user roles. The one or more industry segments, user interests and/or user roles can then be stored in a memory location coupled to the computer processor. Next, a search of a repository of deals can be conducted to identify one or more deals based at least in part, substantially or entirely on a match between (i) the one or more industry segments, user interests and/or user roles from the memory location and (ii) industry segments, user interests and/or user roles associated with the deals. Next, the one or more deals that have been identified are presented to the user.

Another aspect of the present disclosure provides a method for facilitating deals, comprising providing one or more search criteria of a user directed to deals over potential business opportunities. The one or more search criteria include textual, graphical and/or audio information that are indicative of one or more industry segments of interest to the user. Next, using a computer processor that is programmed to identify deals of interest to users, a search of a repository of deals directed to the one or more search criteria can be conducted to identify one or more deals of interest to the user. The search can be conducted without any involvement from the user. The one or more deals that have been identified from the search can be presented to the user on a user interface of an electronic device of the user.

Another aspect of the present disclosure provides a method for facilitating deals, comprising receiving information with respect to a deal over a potential business opportunity from a user. Next, from the information, one or more search criteria can be generated. The one or more search criteria can include textual, graphical and/or audio information that are indicative of one or more industry segments, user interests and user roles. Using a computer processor that is programmed to identify user contacts that may be interested in the deal, a search of a repository of user contacts directed to the one or more search criteria can be conducted to identify one or more contacts of the user that are deemed to be interested in the deal. The search can be conducted without any involvement from the user. Next, the one or more users that have been identified upon the search can be presented to the user on a user interface of an electronic device of the user.

Another aspect of the present disclosure provides a computer readable medium comprising machine executable code that, upon execution by one or more computer processors, implements any of the methods above or elsewhere herein.

Another aspect of the present disclosure provides a computer system comprising one or more computer processors and a memory location coupled thereto. The memory location can include a computer readable medium comprising machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 schematically illustrates a deal process work flow;

FIG. 2 shows a computer system that can be programmed or otherwise configured to implement methods provided herein;

FIG. 3 shows an example taxonomy;

FIG. 4 shows a screenshot of a user interface (UI) with an example rolodex tool;

FIG. 5 is a screenshot of a UI with an example pitch material created for a user;

FIG. 6 shows a screenshot of a UI in which a user is provided with the opportunity to share a given deal with other users;

FIG. 7 shows a screenshot of an example activity feed;

FIG. 8 shows a screenshot of a UI in which a user has prepared a communication to another user to discuss a potential deal that is of interest to the user;

FIG. 9 shows a screenshot of a UI in which a user is preparing a communication to notify another user (e.g., a friend of the user) about a deal;

FIG. 10 shows a screenshot of a UI in which a user has elected to share an opportunity with one or more contacts of the user;

FIG. 11 shows a screenshot of an example UI in which a user is presented with deal opportunities;

FIG. 12 shows a screenshot of an example UI in which a user has selected to update settings of a profile of the user;

FIG. 13 is a screenshot of an example UI that shows an electronic mail (email) template that the user can use to customize a communication to another user;

FIG. 14 shows a graphic that displays the various categories that a network of a user is distributed into;

FIG. 15 shows a profile of a user, as may be generated by the system from information collected from various sources, including network sources;

FIG. 16 shows examples of platform entities that can be included in a system of the present disclosure;

FIG. 17 shows a platform feature flow in which an individual or entity applies for membership;

FIG. 18 schematically illustrates a data ingestion module;

FIG. 19 schematically illustrates a data ingestion work flow;

FIG. 20 schematically illustrates a data processing work flow;

FIG. 21 schematically illustrates a data surface;

FIG. 22 illustrates a distributed crawling system;

FIG. 23 illustrates components of determining a node score;

FIG. 24 illustrates integrating a node sales predication engine into a contact relationships management system, in accordance with embodiments of the invention;

FIG. 25 illustrates a display of leads generated from a predictive lead generator, in accordance with embodiments of the invention; and

FIG. 26 illustrates a display of an automatic researcher, in accordance with embodiments of the invention.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “deal,” as used herein, generally refers to a business opportunity, such as a funding opportunity, merger opportunity, purchase opportunity, or other opportunity with respect to a financial or asset transaction over a business enterprise, such as a company. An example of a deal is a need for financial backing of an emerging company. Another example of a deal is a merger and acquisition. Another example of a deal is a product placement opportunity. Examples of deals include sponsorships and partnerships, such as brand sponsorships, media partnerships, revenue partnerships and distribution partnerships.

The term “user,” as used herein, generally refers to an individual or entity (e.g., Company) that uses systems and methods provided herein. A user may be an individual or company that is interested in engaging in a deal. A user can be an individual or company that is in need of financing or an individual or entity that is interested in funding a business enterprise. A user can be a member of a system of the present disclosure. Examples of users include individuals in need of investment and investors (e.g., venture capitalists).

The term “industry segment,” as used herein, generally refers to a distinct component of a business, such as a product line or a category of products, or a grouping of similar types of businesses, such software, clean technology, biotechnology, consumer equipment, or food.

The present disclosure provides platforms that facilitate deals. Such platforms include back end systems that can identify deals that may be of interest to users and help users prepare deals, and front end systems that present such deals to users. Platforms of the present disclosure can accurately match deals with the individuals that may be best suited or positioned to engage in those deals. This can advantageously enable users to close deals in a manner that helps the user maximize the value of such deals.

Provided herein are systems that make the workflow of deal making from inception to close more efficiently. Such systems can include a marketplace that allows users to uncover high value opportunities across various markets. Such systems can help a user route a deal or business opportunity to individuals or entities that may be best suited to fulfill them. Such individuals or entities may be in a network of the user, such as a social network, including first degree connections within a network (e.g., immediate friends or colleagues) and second degree connections (e.g., network of a network, including friends of friends). The marketplace can include curated (vetted) deal makers and business executives across many industries (e.g., technology, brand, entertainment, finance, real estate, philanthropy, fortune 500 executives, etc.) that are normally not accessible. Systems of the present disclosure can provide routing tools to allow users to route deals and opportunities to others users based, for example, on their deal interest areas.

Systems of the present disclosure provide users with various deal tools that can enable deal management, deal discovery (e.g. through a deal marketplace or deal network) and network intelligence. Deal tools of the present disclosure can allow users to create, route and browse deals. Deal-flow tools of the present disclosure can enable users and teams to manage deals from inception to close. A deal marketplace (or deal exchange) can be implemented by a system that is specifically programmed for various functions, such as enabling users to create deals, route deals and browse deals. The system can include deal intelligence that analyzes users' networks to allow targeting of deals. The networks can include users connected to other individuals or entities on any platform.

Systems of the present disclosure can enable a user to employ a team-based approach to deal making. Systems provided herein enable deal transparency, including workflow transparency that can allow teams or groups of users to see who is working on which deal and consolidate knowledge around deal relationships and status internally. This also allows users to gain a high-level view of their team's progress towards their objectives. Systems provided herein can enable network transparency, which allows teams to harness their full extended networks for both sourcing and closing deals, from identifying new deals and opportunities to locating the best person across the entire team—or company—network to get a deal done. In addition, systems provided herein can include deal networks that provide a high-value source of inbound deal opportunities and an opportunity to close deals with other users, individuals or entities. Membership and deal flow can be curated to ensure these opportunities are meaningful to users.

### Methods for Facilitating Deal Making

In an aspect, the present disclosure provides methods for facilitating deals. Such methods can significantly improve the manner in which users identify deals of potential interest, which can minimize the time a user spends to find a deal and helps maximize the potential value to users.

Methods for facilitating deals provided herein can be implemented using a computer system (“system”) that is programmed or otherwise configured to facilitate deals, as described elsewhere herein. The system can be in communication with one or more users that may be interested in engaging in a deal.

In some embodiments, a method for facilitating deals comprises accessing one or more network sources of a user and identifying content in the one or more network sources. The content can comprise textual, graphical and/or audio information. Next, using a computer processor, the content is searched for textual, graphical and/or audio information that are indicative of one or more industry segments. The one or more industry segments can then be stored in a memory location. In some cases, textual, graphical and/or audio information identified in the content is compared against textual, graphical and/or audio information being correlated with industry segments to identify the one or more industry segments.

Next, a search of a repository of deals is conducted to identify a match between (i) the one or more industry segments from the memory location and (ii) industry segments associated with the deals. The repository can comprise potential business opportunities. The repository can include funding or acquisition deals. The repository can include details of such deals and one or more users (e.g., individuals or companies) that are associated with such deals.

Next, the one or more deals that have been identified are presented to the user. The one or more deals can be presented to the user in a report. The report can be presented to the user on a user interface of an electronic device of the user. The user interface can be a graphical user interface (GUI) or a web-based user interface. The electronic device can be a portable (or mobile) electronic device.

In some cases, the user can have a user profile that includes information of relevance to the user's interests, including potential deals. The profile of the user can be generated or updated with one or more criteria that can be used to perform the search. The one or more criteria can include the one or more industry segments.

The one or more network sources can comprise a plurality of network sources, such as at least 2, 3, 4, 5, 6, 7, 8, 9, or 10 network sources. The one or more network sources can include social networks (e.g., LinkedIn®, Facebook® or Twitter®). In such a case, the content can be from a newsfeed, wall post, or profile of the user. The profile can be associated with a given network source of the one or more network sources. As an alternative or in addition to, the one or more network sources can include electronic communications (e.g., email), an intranet, and/or the Internet (or World Wide Web). This can provide the ability for information to be collected as the user receives or transmits email, navigates an intranet, and/or navigates the Internet.

The one or more deals can be identified based on various factors, such as interests of the user, a geographic location of the user, industry segments of interest to the user, social or work information of the user, and/or education information of the user. For example, a user that works in the software industry may be presented with deals including funding opportunities for emerging software companies.

The one or more industry segments can include at least 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 400, 500, 600, 700, 800, or 900 industry segments. The industry segments can be different industry segments.

The search for deals can be directed to one or more search criteria. In some embodiments, a method for facilitating deals comprises providing one or more search criteria of a user directed to deals over potential business opportunities. The one or more search criteria include textual, graphical and/or audio information that can be indicative of one or more industry segments of interest to the user. Next, using a computer processor, a search of a repository of deals directed to the one or more search criteria is conducted to identify one or more deals of interest to the user. The one or more deals can be identified by comparing the one or more search criteria against textual, graphical and/or audio information associated with one or more deals in the repository. In some cases, the one or more deals of interest to the user are identified without any involvement from the user. Next the one or more deals that have been identified are presented to the user.

The one or more search criteria can be identified in a profile of the user. In such a case, a user profile of the user can be generated or updated with user profile information, such as, for example, interests of the user, a geographic location of the user, industry segments of interest to the user, social or work information of the user, and/or education information of the user.

In some cases, the one or more search criteria can be provided by the user. For example, the user can input a search string with search criteria (e.g., “clean technology”). The one or more search criteria can be inputted in a user interface, which can include, for example, an input field for the search criteria.

The one or more industry segments can be identified by the user. For example, in a profile of the user, the user can indicate which industry segments are of interest to the user. As an alternative, one or more industry segments can be identified without any involvement from the user.

In some cases, the one or more search criteria can be provided based upon a search of one or more network sources of the user. The one or more network sources can include a plurality of network sources. The one or more network sources can include social networks.

The search can be directed to one or more industry segments. In some cases, the search is directed to a given industry segment (e.g., software). As an alternative, the search is directed to multiple industry segments (e.g., software and biotechnology).

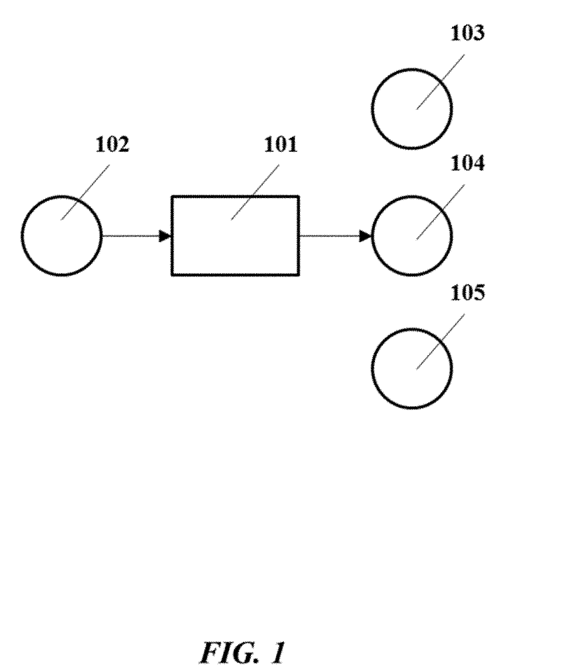

FIG. 1 schematically illustrates a deal process flow. A system 101 that is programmed or otherwise configured to facilitate deals is in communication with a first user 102, second user 103, third user 104 and fourth user 105. The first user 102 is in need of engaging in a deal with one or more other users. For example, the first user 102 is an owner of a startup that is in need of financing. The system 101 identifies the second user 103, third user 104 and fifth user 105 as individuals or entities that may be interested in engaging in the deal with the first user 102. The users 103-105 are presented with the opportunity from the system 101. The third user 104 agrees to engage in the deal with the first user 102.

The system 101 can be programmed or otherwise configured to identify one or more users that are more likely that other users to engage in the deal with the first user. The system 101 can be programmed to perform a search of profiles of the other users to identify which of the other users have engaged in similar deals or have interests that are aligned with the deal. For example, the system 101 can identify whether industry segments of interest to any of the other users match or are related to an industry segment associated with the deal.

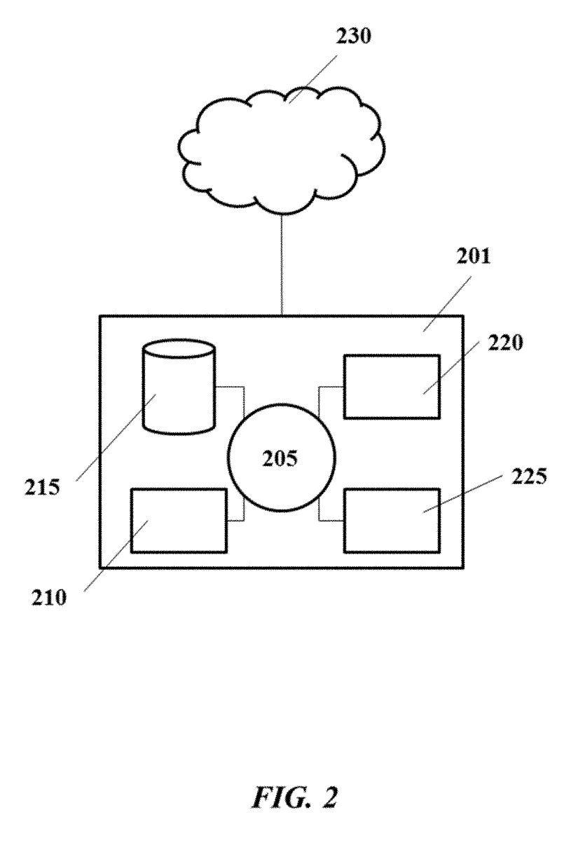

FIG. 2 shows a system 201 that is programmed or otherwise configured to facilitate deals. The computer system 201 includes a central processing unit (CPU, also “processor” and “computer processor” herein) 205, which can be a single core or multi core processor, or a plurality of processors for parallel processing. The computer system 201 also includes memory or memory location 210 (e.g., random-access memory, read-only memory, flash memory), electronic storage unit 215 (e.g., hard disk), communication interface 220 (e.g., network adapter) for communicating with one or more other systems, and peripheral devices 225, such as cache, other memory, data storage and/or electronic display adapters. The memory 210, storage unit 215, interface 220 and peripheral devices 225 are in communication with the CPU 205 through a communication bus (solid lines), such as a motherboard. The storage unit 215 can be a data storage unit (or data repository) for storing data. The computer system 201 can be operatively coupled to a computer network (“network”) 230 with the aid of the communication interface 220. The network 230 can be the Internet, an internet and/or extranet, or an intranet and/or extranet that is in communication with the Internet. The network 230 in some cases is a telecommunication and/or data network. The network 230 can include one or more computer servers, which can enable distributed computing, such as cloud computing. The network 230, in some cases with the aid of the computer system 201, can implement a peer-to-peer network, which may enable devices coupled to the computer system 201 to behave as a client or a server.

The CPU 205 can execute a sequence of machine-readable instructions, which can be embodied in a program or software. The instructions may be stored in a memory location, such as the memory 210. Examples of operations performed by the CPU 205 can include fetch, decode, execute, and writeback.

The CPU 205 can be part of a circuit, such as an integrated circuit. One or more other components of the system 201 can be included in the circuit. In some cases, the circuit is an application specific integrated circuit (ASIC). The CPU 205 can be programmed to perform one or more specific functions, such as any of the methods provided herein.

The storage unit 215 can store files, such as drivers, libraries and saved programs. The storage unit 215 can store user data, e.g., user preferences and user programs. The computer system 201 in some cases can include one or more additional data storage units that are external to the computer system 201, such as located on a remote server that is in communication with the computer system 201 through an intranet or the Internet.

The computer system 201 can communicate with one or more remote computer systems through the network 230. For instance, the computer system 201 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 201 via the network 230.

Methods as described herein can be implemented by way of machine (e.g., computer processor) executable code stored on an electronic storage location of the computer system 201, such as, for example, on the memory 210 or electronic storage unit 215. The machine executable or machine readable code can be provided in the form of software. Additionally, the machine executable or machine readable code may be tailored to implement methods of the invention as described herein. In some examples, the code may be tailored to facilitate deals. During use, the code can be executed by the processor 205. In some cases, the code can be retrieved from the storage unit 215 and stored on the memory 210 for ready access by the processor 205. In some situations, the electronic storage unit 215 can be precluded, and machine-executable instructions are stored on memory 210.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 201 can include or be in communication with an electronic display that comprises a user interface (UI) for providing, for example, deals of potential interest to users. Examples of UI's include, without limitation, a graphical user interface (GUI) and web-based user interface.

In some examples, the UI can include a window for presenting deals to a user. The deals can be targeted deals, which can be selected from a plurality of deals based on one or more interests of the user. The UI can also display one or more other users that are associated with such deals. The one or more other users can be individuals or organizations (e.g., companies). The UI can include a navigation menu that includes icons that permit the user to access various features of the system, such as an (i) opportunity generation tool that permits the user to prepare a deal opportunity to be distributed by the system to one or more other users that may be interested in the deal opportunity, and (ii) a profile tool that permits the user to generate a user profile having contacts of the user and one or more interests of the user, including at least one industry segment of interest.

The system can implement methods of the present disclosure by way of one or more algorithms. An algorithm can be implemented by way of software upon execution by one or more computer processors. In some examples, an algorithm for facilitating deals comprises a machine learning component (e.g., support vector machines) that learns from previous deals users have been involved in, whether those were successful or unsuccessful deals, and enables the system for facilitating deals to predict future deals that the users may be interested in. This can enable the system to predict at an accuracy of at least about 50%, 60%, 70%, 80%, 90%, or 95% whether a given deal is of potential interest to a user.

The system can be programmed or otherwise configured to prepare and provide deal graphs to users. A deal graph can aid the system to solicit information from a user with respect to the types of deals and opportunities that may be of interest to the user. The deal graph can include a guided questionnaire that presents the user with one or more questions that are directed to learning about deals of interest to the user. The deal graph can map relationships between users and deals that they are involved in. The deal graph can be generated by the system and include mapping among users and deals based on information identified by the system.

The system can determine a social network of a user, which can include other users that may be at least one, two or three degrees removed from the user. The system can present deals of potential interest to the user based on how many degrees the user is removed from other users. For example, deals from first degree connections may be presented immediately to the user, while deals from second degree connections may be presented to the user only if they are within an industry segment of interest to the user.

Systems of the present disclosure can help users make sense of who they know. Contacts of a user may be spread across social networks and communication platforms (e.g., Facebook®, LinkedIn®, Twitter® and Gmail®), and a contact database of the user (e.g., address book of an electronic device of the user). This can result in a network of the user being fragmented and disorganized, making it increasingly difficult for a user to understand who the user knows. Systems provided herein can advantageously aggregate all of a user's contacts from various sources, including social networks and contact database. This can enable the user to better leverage a network of the user to fulfill their business opportunities. In some examples, contact categorization starts at a high level where the system aims to deduce a contact type into a variety of categories (e.g., startup founder, startup advisor, investor, brand, entertainment company, press/media, startup advisor, etc.). A taxonomy of the system can then categorize by a variety of fields, including industry vertical, market sectors, business model, market niches, general interest (e.g., education, sports, hobbies, etc.). A network mapping module of the system can then help the user find other users who may be interested in engaging in a deal with the users. The network mapping module may first start with an immediate network of the user, and subsequently proceed to a secondary and tertiary network of the user.

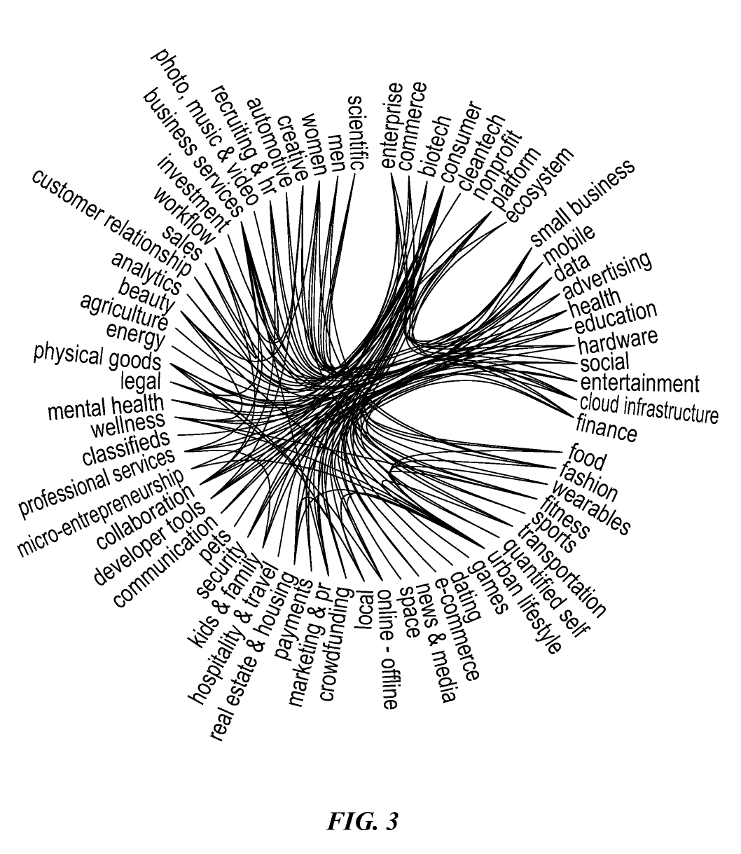

FIG. 3 shows an example taxonomy, which shows various industry segments at the perimeter. The industry segments can include at least 218 different industry segments (e.g., enterprise, commerce, biotech, consumer, cleantech and nonprofit). The industry segments are graphically shown to be related to one another through tie lines.

The system can employ predictive models to predict what types of deals users (e.g., individuals or businesses) are interested. In some cases, the system employs natural language processing and a review of various others sources (e.g., social media, blogs and news articles) to ascertain a user's interests with respect to deals. The system can strategically map a network of the user to identify high value opportunities. The can enable the system to effectively map opportunity (e.g., a potential deal) with user interest.

### Workflows

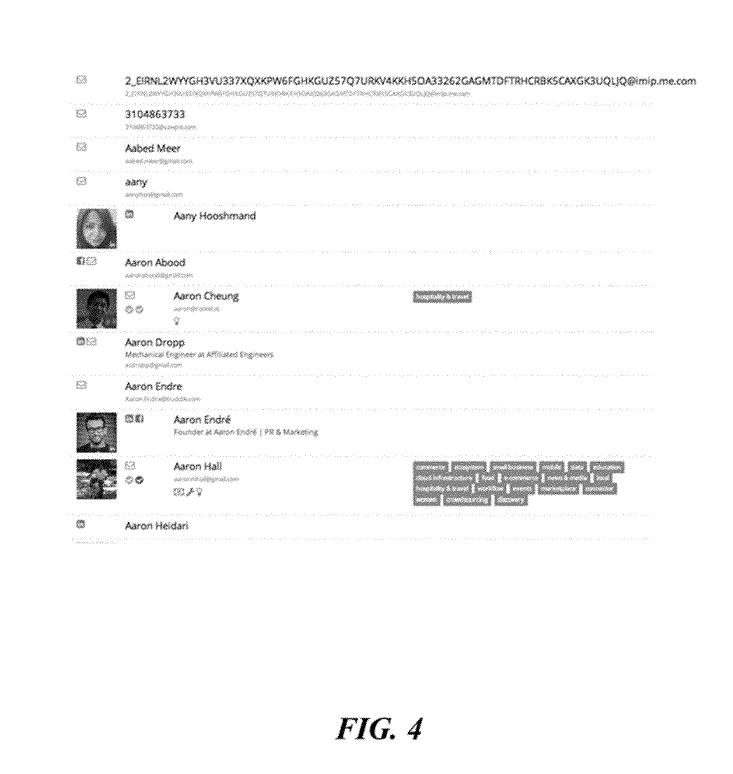

The present disclosure provides workflows for facilitating deals. The workflow for at least some types of deals may be the same. In a first workflow, a user has a criteria identified and knows what deal the user is looking to fulfill. In a second workflow, the user may not be clear on what specific deal they want to do, but the user has a high level objective in mind (e.g., attain capital or increase market share) and wants to analyze a network of the user to see what sort of deal (e.g., investment or revenue partnership, or merger and acquisition) may make sense. The second workflow may commence with a rolodex tool (see, e.g., FIG. 4) of the system, where the user can conduct searches on contacts of the user based on search criteria (e.g., keywords) and create one or more lists, and then create a deal. In this scenario, a target audience is identified prior to creation of the deal. FIG. 4 shows a screenshot of an example rolodex tool, which displays users and user interests (e.g., industry segments).

The system can implement a given workflow in various phases. In a research phase, the system reviews a business objective of a deal of the user and identifies an industry associated with the business objective and one or more industry verticals. In an example, the objective is to build high school sports content on a social media network, and the system identifies the different parties in an industry vertical and within one or more geographic regions. Once the system has identified the one or more industry verticals and a general strategy and approach with the business objective, the system specifies the target stakeholders and types of companies they seek to partner with (e.g., eCommerce companies) and one or more deals they are looking to fulfill.

The system can then identify users that may be interested in the deal of the user. The system can identify first degree connections (e.g., contacts of the user), second degree connections (e.g., friends of friends), an organization's network, or a market place of the system, which can include other users of the system and their networks.

Next, the system can create pitch material for the user. The pitch materials can include information that can be relevant to the deal, including a business plan. The system can help the user create pitch material, such as, for example, provide the user with a user interface that has input fields which the user can use to input information that may be relevant to do deal. In some cases, the system can automatically create pitch material for the user. For example, the system can automatically create at least some, most or all of the pitch material for the user. The system can employ a database of pitch material from various deals (e.g., successful deals) to prepare suggested pitch material for the user. The pitch material can be prepared for a given target audience (e.g., specific investors or investors generally).

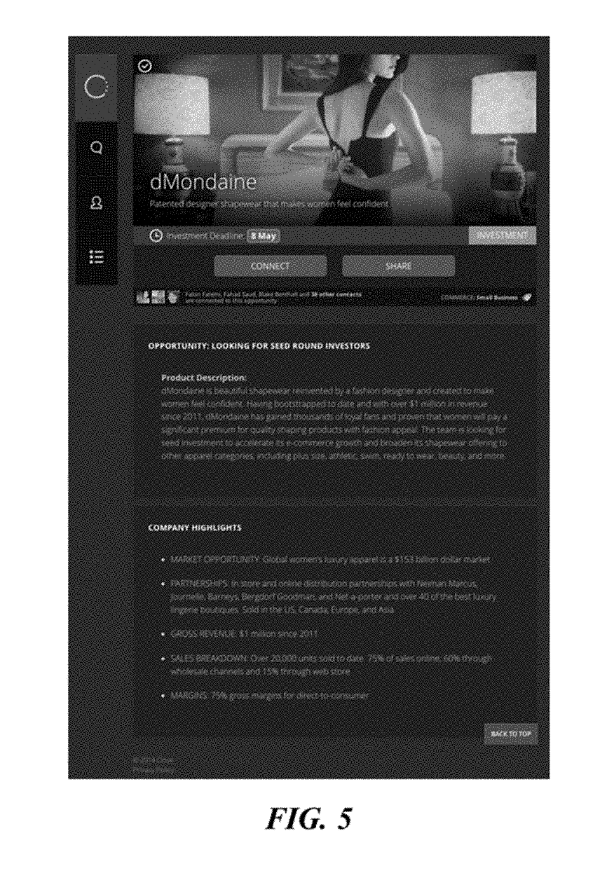

Pitch material can determine conversion for the opportunity. In some examples, the pitch material can include creation of a pitch deck, the pitch electronic communications (emails), strategic common responses, etc. Optimizing this content for each target audience can be critical for conversion (i.e., getting an introduction or initial response to proceed with the next step). FIG. 5 is a screenshot of an example pitch material created for a user.

The system can guide the user to create an opportunity with optimal content for fulfilling that type of deal. The system can suggest text, images, audio, video, metrics, and additional content that it deduces can optimize conversion for the target audience and deal type.

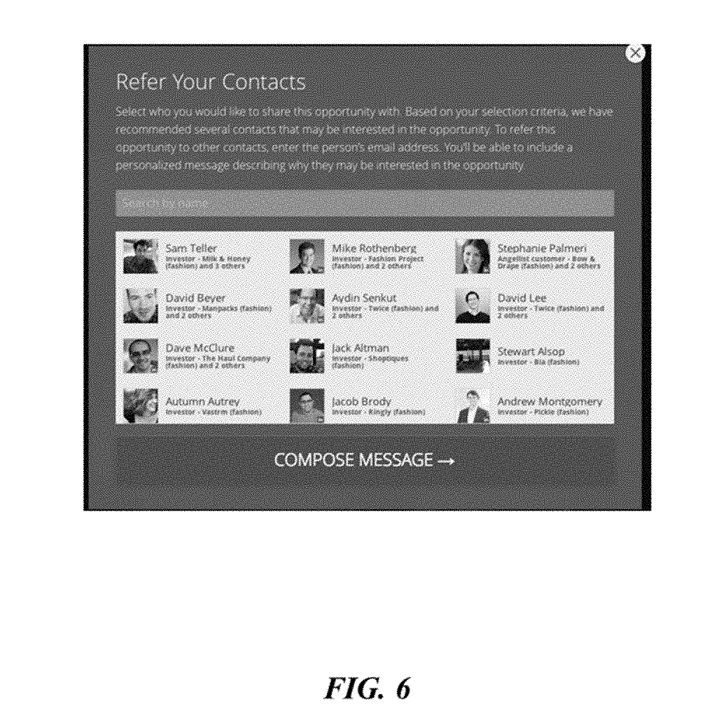

The system can conduct outreaching to one or more users that may be interested in engaging in a deal with the user. When conducting outreach, the user or the system can create a pitch template that can be customized for each target user when conducting outreaching. FIG. 6 shows a screenshot in which the system has provided the user with the opportunity to share a given deal with other users. The user can select which other users the user wishes to direct the deal to. The system can present users that the system deems to be most likely to be interested in the deal to the user.

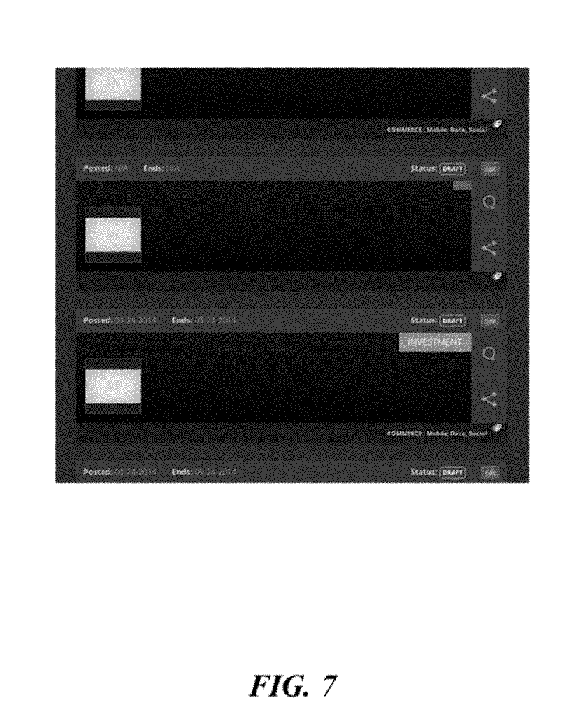

A deal management tool of the system can track deals and perform analysis on the deals. FIG. 7 shows a screenshot of an example activity feed of the system. The deal management tool can show one or more electronic communications (e.g., emails) that are exchanged between the users and other users. The communications can be indicative of the progress of the deal, such as whether the deal is progressing to completion. The system can collect or aggregate emails related to a deal and provide the user with tools for a deal team to manage tasks required to complete a deal and collaborate using one or more electronic communication tools, such as messaging. This can include creating a deal workspace here the user can determine based on activity the status of deals. The deal workspace can include a user interface that enables the user to determine the status of deals. In some cases, the deal workspace is a deal room.

The system can determine if and when a deal has reached completion, such as when a deal has closed or failed to close. This can include a set of reporting and analytics tools at a macro level for the user or an administrator to understand and quantify business development efforts.

The system can provide various features and functionalities. The system can provide a deal marketplace (or network), which can be limited to users (e.g., subscribing members of the system). The marketplace can be part of a closed, invite-only platform that helps connect the right opportunities to the right users. It can include a deal portal (or feed) where users can discover deals that fit their interest area(s) and can have access to route deals to other users (e.g., high profile users) that can potentially fulfill them.

The system can be part of a larger system, such as a customer relationship management (CRM) system. The system can be integrated with an existing CRM (e.g., SalesForce®) and provide a suite of platform tools that can allow the user to leverage to fulfill a deal of the user.

The system can aggregate contacts of a given organization in one place and help the organization (e.g., business) make sense of such contacts. This can allow users at the organization to be able to collaborate more effectively to get deals done. This can include the opportunity for other users to access their own to fulfill opportunities for the organization. The other users may be in a network of the user, such as a first degree or second degree connection.

The system can include customization tools and additional third party integrations for companies to be able to incorporate a platform of the system into other systems.

In some cases, the system can provide select individuals or companies (e.g., startups, investors, brands or executives) the ability to act as gatekeepers on the system. Such individuals or companies can vet deals and, in some cases, source opportunities that can fulfill business objectives associated with the deals and help keep the deals associated with the system. The system can curate an opportunity page of a given and target their opportunity to the relevant users on the system.

The system can enable application programming interface (API) access and integration. The system may offer API integration and access for other verticalized platforms (e.g., AngelList, FundersClub, or Exitround) to access a routing algorithm and help route relevant opportunities on the system to relevant user(s).

The system can provide various features and functionalities, which can provide for a flexible platform for deal making. The system can provide a deal widget and allow users (e.g., companies) internally or platforms externally to leverage deal tools and routing system with a routing algorithm. The system can also allow users access a whitelabel version of a deal platform and add various customizations to integrate the platform in their respective organizations.

The deal widget can be integrated with a user interface of an electronic device of a user, such as a web-based user interface (e.g., web browser). As an alternative or in addition to, the deal widget can be integrated with the user's company platform, such as hardware and/or software in the user's company intranet or other internal network. The deal widget can enable the user to identify potential deals from various third party applications (apps), such as third party software that may not be directly related to deals, such as, e.g., third party email apps (e.g., Gmail®) or third party contacts or social networking apps (e.g., Facebook® or LinkedIn®).

Information with respect to contacts and deal interests of a user can be collected by the system from various sources, such as one or more social networks of the user, electronic communications of the user, an intranet of an organization of the user, and/or the Internet. For example, an electronic device of the user can include a web browser extension or email extension that can assess contacts of a user and enable the user to view their contacts. The extension can bring the electronic device of the user in communication with the system, which can enable the contacts to be uploaded to (e.g., synchronized with) a contacts database of the system. In some cases, the extension enables the user to view contacts related to content the user is browsing or information with which the user is interfacing.

### Methods for Facilitating Deals

Another aspect of the present disclosure provides methods in which a facilitator facilitates a deal with or without a fee or interest in a transaction over the deal. In some embodiments, a facilitator owns or manages a deal system that includes users that may be interested in engaging in deals with one or more other users. The system can be as described elsewhere herein. The system can include a platform with various tools (or modules) that enable (i) users to search for or be presented with potential deals, and (ii) users to make potential deals available to other users. The facilitator may not be directly associated with any of the users. For example, with reference to FIG. 1, the system 101 can be associated with the facilitator.

In some cases, a method for facilitating deals comprises providing a system of a facilitator that includes a computer processor that is programmed to facilitate deals. Next, using the computer processor, a search of a repository of deals directed to the one or more search criteria is conducted to identify one or more deals of interest to a user. The one or more deals can be identified by comparing the one or more search criteria against textual, graphical and/or audio information associated with one or more deals in the repository. The one or more search criteria can include textual, graphical and/or audio information that are indicative of one or more industry segments of interest to the user. In some cases, the one or more deals of interest to the user are identified without any involvement from the user. Next the one or more deals that have been identified are presented to the user.

Next, the system can bring the user in communication with another user that is associated with a deal among the one or more deals. The user can be brought in communication with the other user upon request from the user. The request can be provided in electronic form, such as upon the user directing an electronic communication to the system requesting that the system bring the user in communication with the other user.

The user can be brought in communication with the other user upon permission from the other user. The permission can be provided in electronic form, such as upon the system directing an electronic communication to the other user requesting permission.

In some cases, the user can elect to notify one or more other users about the deal among the one or more deals. For example, the user may find that the deal is of interest to the one or more other users. The user can forward the deal to the one or more other users, who may subsequently choose to review the deal to determine whether it is of interest to them.

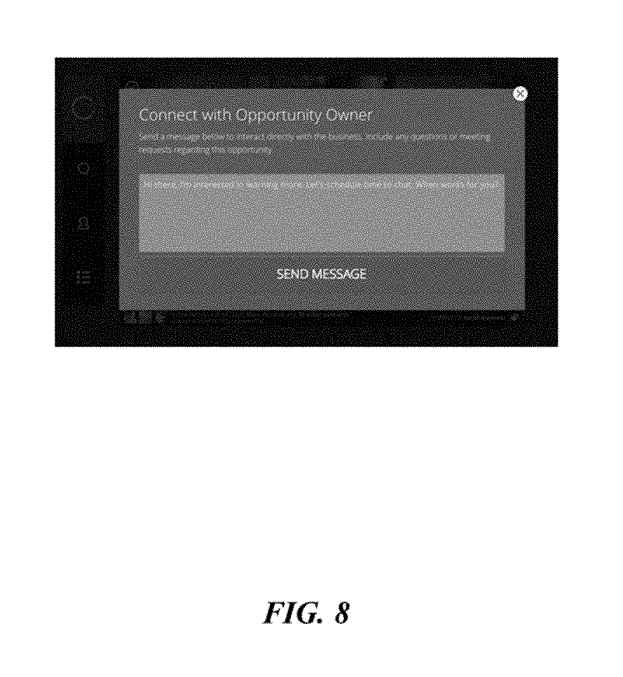

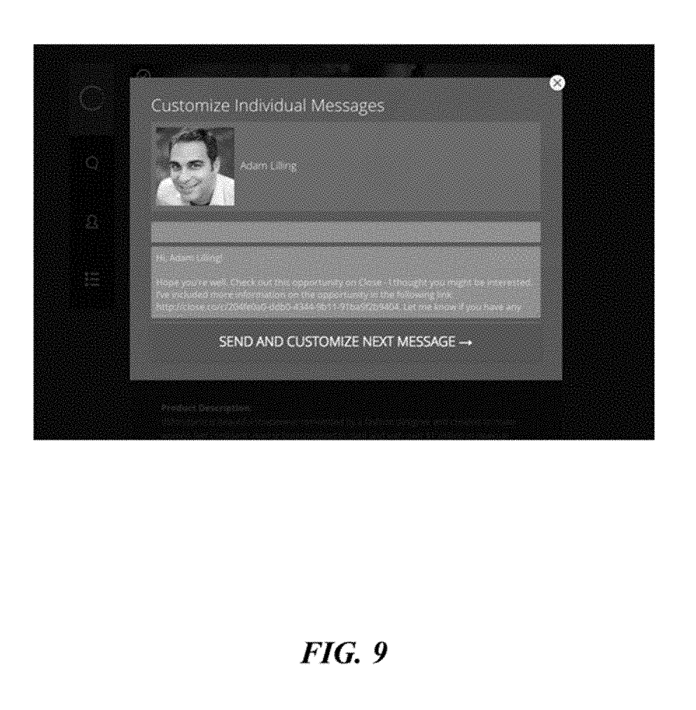

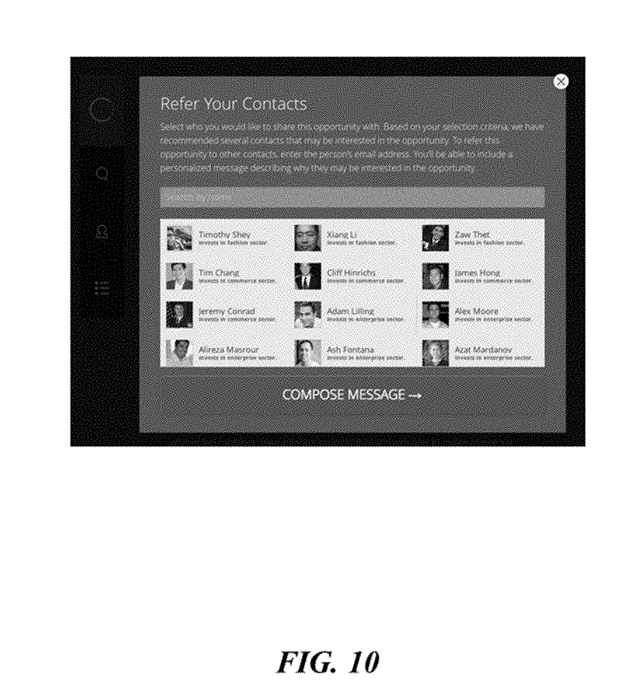

FIG. 8 shows a screenshot of a UI in which a user has prepared a communication to another user to discuss a potential deal that is of interest to the user. The user can send the communication and await a response from the other user. FIG. 9 shows a screenshot of a UI in which a user is preparing a communication to notify another user (e.g., a friend of the user) about a deal of potential interest to the other user. The user can send the communication to the other user, and the other user can review the deal to determine whether it is of interest. As an alternative or in addition to, the user can elect to share an opportunity with one or more contacts of the user from a contacts list, as shown in the screenshot of the example UI of FIG. 10.

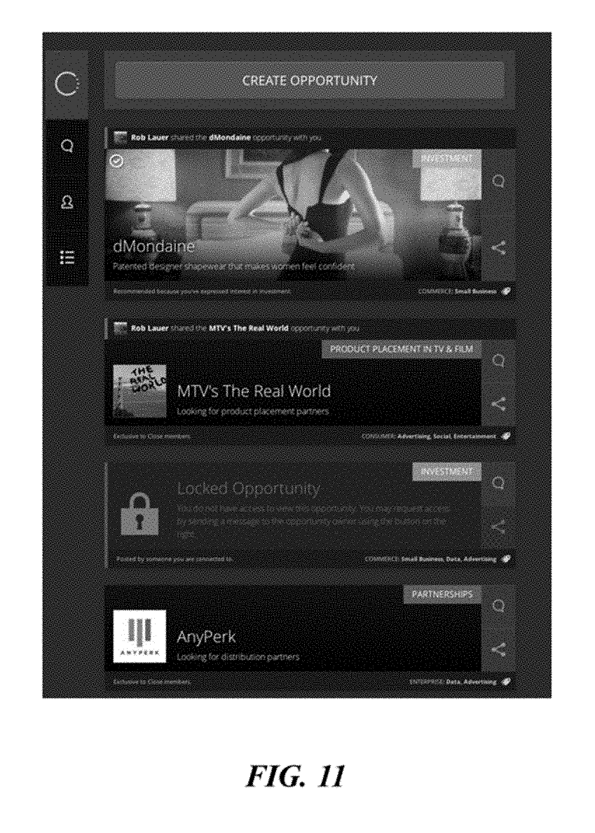

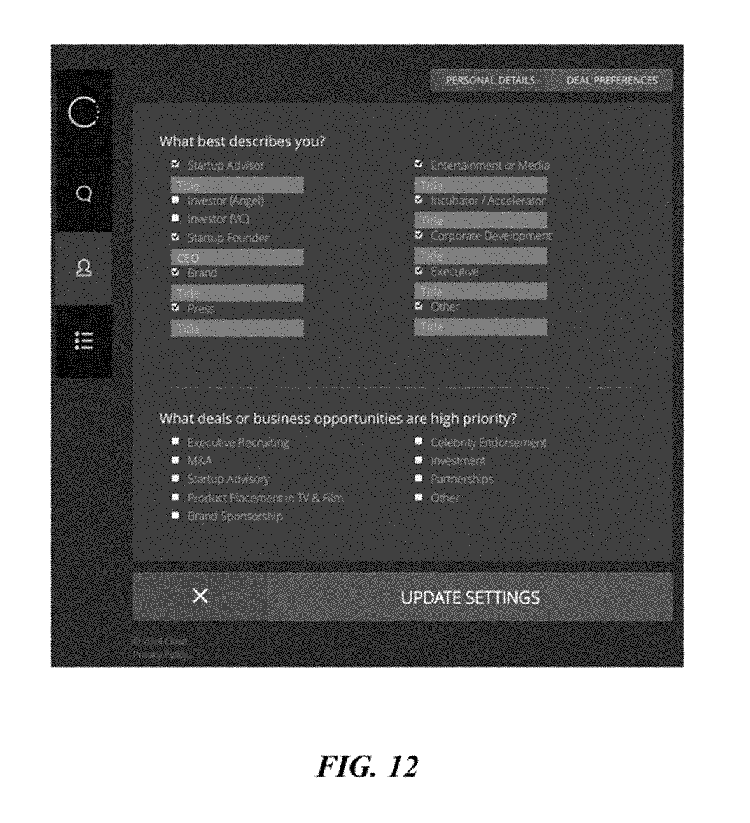

FIG. 11 shows a screenshot of an example UI in which a user is presented with deal opportunities (e.g., request for product placement partners for MTV's The Real World) from another user. The UI also indicates the type of opportunity, such as investment, request for product placement, or partnership. From the UI the user can select a given opportunity, or access other features offered by the system, such as searching for other opportunities or creating an opportunity (deal). The user can use the UI to access a profile of the user, which can include systems settings. FIG. 12 shows a screenshot of an example UI in which the user has selected to update settings of a profile of the user. The settings include a description of the user (“What best describes you?” and “What deals or business opportunities are high priority?”). The system can employ the settings to target deals to the user, such as deals within a targeted industry segment or a particular type of deal (e.g., executive recruiting, merger and acquisition (M&A), startup advisory, product placement in television and film, brand sponsorship, celebrity endorsement, investment, partnership, or other type of deal).

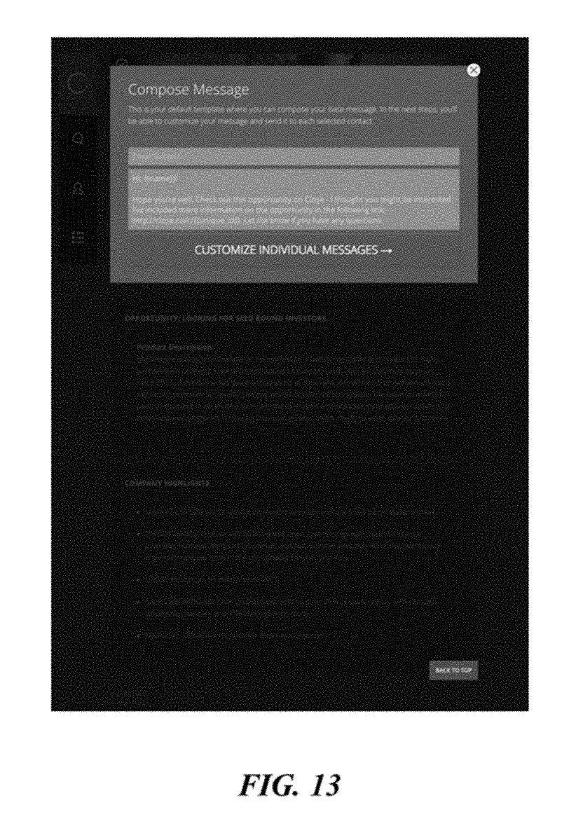

The system can aid the user to prepare a deal opportunity to be presented to one or more other users. The system can present the user with a default template to use to prepare the deal opportunity, which can be presented on a UI of an electronic device of the user. The system can also provide the user with a template communication to direct the deal opportunity to one or more other users. FIG. 13 is a screenshot of an example UI that shows an email template that the user can use to customize a communication (e.g., email) to another user.

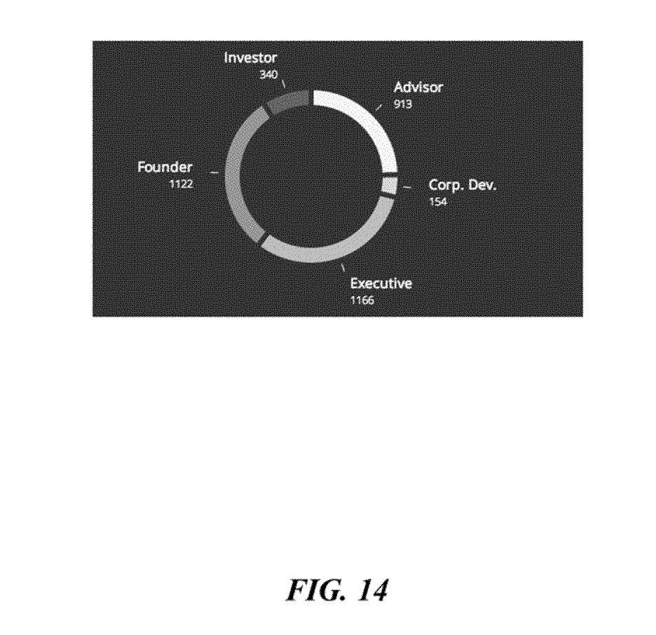

The system can help the user visualize a network of the user by categories. This can help the user direct network growth along a given category, for instance. In an example, FIG. 14 shows a graphic that displays the various categories that a network of a user is distributed into (i.e., investor, founder, advisor, corporate development, and executive). The graphic can be displayed on a UI of the user.

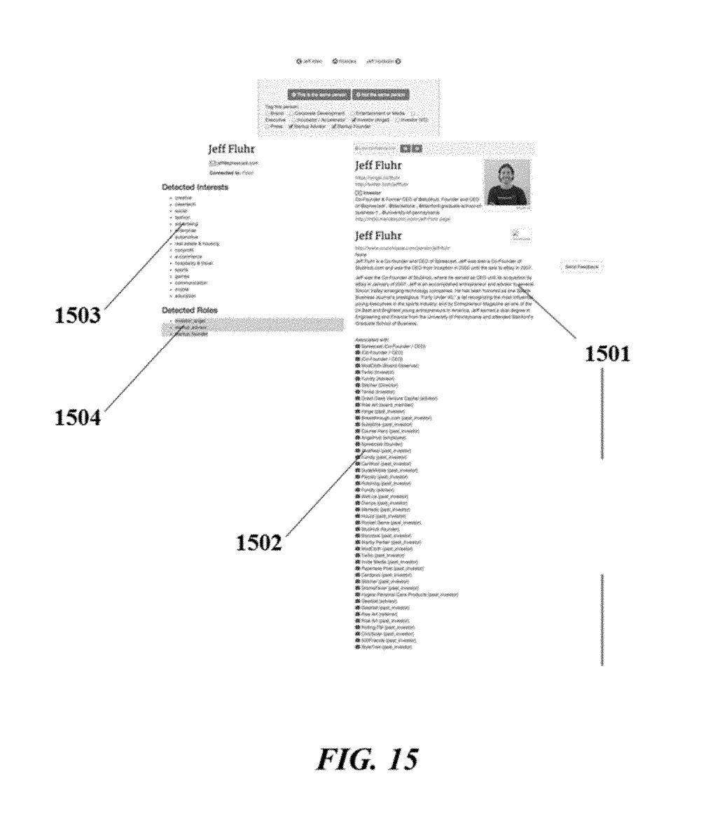

FIG. 15 shows a profile of a user, as may be generated by the system from information collected from various sources, including network sources. The profile includes a description 1501 of the user, which can be generated and updated by the user or by the system. The profile also includes a list 1502 of individuals and entities (e.g., companies) that the user is associated with. The profile also includes a list of interests 1503 and a list of roles 1504 of the user that have been detected by the system. The roles include angel investor, startup advisor and startup founder. However, other roles can be included if detected by the system. Such roles can be business or deal roles. The interests 1503 and roles 1504 can be detected based upon a search (e.g., keyword search) of one or more sources of the user, such as network source (e.g., social network).

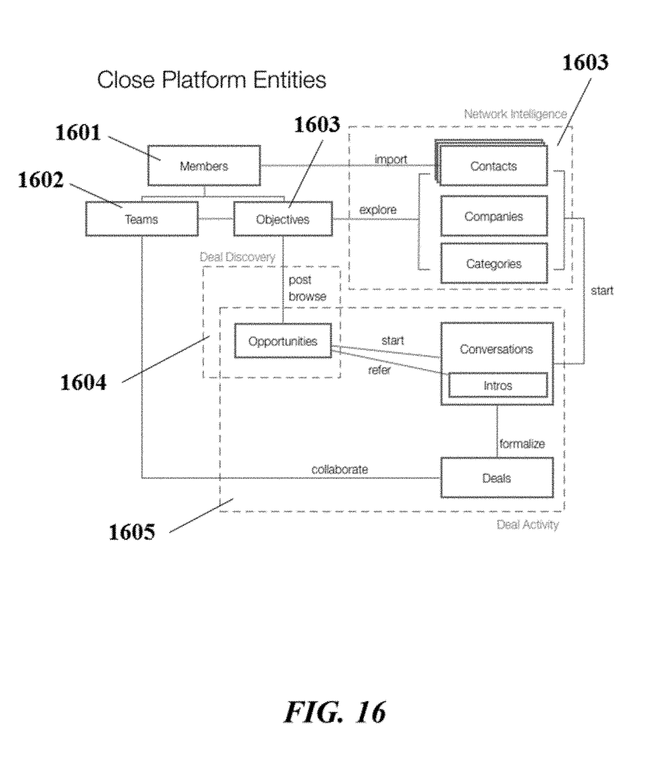

The system can include a platform of entities, as shown in FIG. 16. The platform includes members (or users) 1601, which can be part of teams 1602 and be associated with objectives 1603, such as deal objectives. Contacts and interests of the user can be collected by the system as part of network intelligence 1603. Under deal discover 1604, the system can search for one or more deals that may be of interest to the user and present the one or more deals to the user. Under deal activity 1605, the user can be presented with deals and be able to engage in conversations with other users over the deals. The user can also be introduced to users that may have deal opportunities or be interested in deal opportunities.

The system can look for implied relationships between users and other individuals and entities, and others in an extended network, based, for example, on co-occurrence of key activities (e.g., both invested in the same company). The system can source extended profiles for contacts in users' networks from multiple data sources, such as social networks. The system can apply a confidence score to extended profiles to determine whether the data applies to the original contact.

The system can be programmed to analyze personal and business (e.g., corporate) interests to predict deal interest. For example, the system can model interests along a taxonomy of industry sectors and interest niches, as well as different types of deals (e.g., investment, mergers and acquisitions, etc.). The system can be programmed to analyze business activities to infer deal suitability. Past behavior (e.g., angel investment) of a user or group of users can be used to predict whether a person is likely to be interested in a particular deal or type of deal. In some situations, the system can suggest the deal or type of deal that a given user (e.g., an individual or business) should be engaging in and help connect the user to the relevant decision maker(s), such as a decision maker at a company associated with a given deal. In some examples, such connection can be made through first or second degree connections, or both first and second degree connections.

The system can personalize deals to a user based on interests and activities of the user. For example, the system can parse data about one or more business objectives of the user to rank opportunities. A profile of the user can display other users, individuals or entities that maybe connected to the user.

The system can calculate and display deal analytics to track progress of deals and suggest next actions to the user. Deal-flow management tools of the system can allow the user to view relevant information about their deals in progress. The system can also identify changes in users' networks and interests and provide targeted (or smart) alerts.

In some cases, the system collects a fee from the user for facilitating a deal, such as for bringing a user in communication with another user. The fee can be collected for the facilitator. The fee can be collected on a subscription basis, such as a yearly subscription, or on a per-use basis.

In some cases, the facilitator can facilitate deals without charging users a fee. As an alternative, the facilitator can charge a subscription fee for users to have access to the system and various platforms and tools of the system. For example, the facilitator can charge each user an annual fee from about $10,000 to $25,000 to have access to the system, including deals of the system. This can be for premium features and per-use license fees for team and enterprise based platforms of the system.

The facilitator can provide various features of the system for free, or impose a fee on a temporal or use basis. For example, the facilitator can request a fee or commission (e.g., $50,000) for use of a deal graph. The fee may be shared with a user of the system that helped facilitate the closing of a deal through introduction to their network. For example, the facilitator can share 50% of such fee with the user that helped facilitate the closing of the deal.

In some cases, the facilitator collects a fee (e.g., on monthly or yearly basis) and/or a minimum equity (e.g., 1% equity). For example, the facilitator can collect a monthly fee from about $5,000 to $50,000 and/or receive a minimum of 1% equity (or stake) in a transaction over a deal. The equity or stake may not be tied to an outcome or performance of a given deal. If the facilitator collects equity, then in some cases the fee may not be collected. In some examples, the equity or stake is collected in exchange for advice around a business objective. As an alternative, the facilitator can receive a minimum equity or stake in a given deal (e.g., 1%) for all transactions associated with the deal.

The facilitator can provide additional services, which can be provided for free or for a fee. For example, the facilitator can actively manage the user's presence on the system, such as by acting as the user's gatekeeper and vetting potential deal opportunities for the user, sourcing one or more deals for the user, helping the user close a deal, and have a more active role in prepping and helping the user with negotiations with respect to the deal. In some situations, the facilitator can be actively involved with the deal, such as in a negotiation (e.g., negotiation over deal terms). As an alternative or in addition to, the facilitator can suggest relevant individuals to help or advise on a deal. Such individuals may be maintained in a database of the system. The database may include a designator over which types of deals or industry segments such individuals may be able to help or advise the user.

### Data Process Workflow

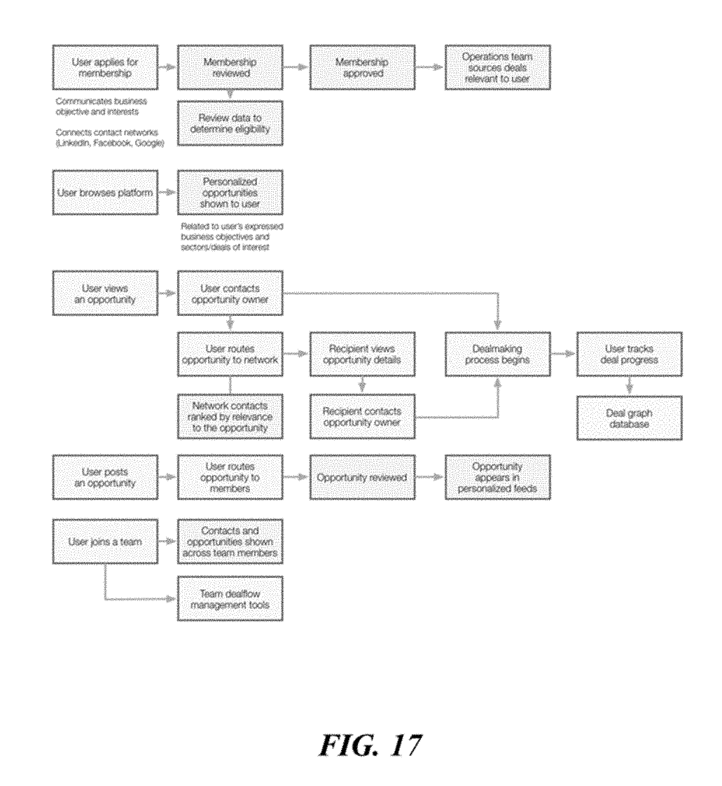

Systems of the present disclosure can include platforms with various features. FIG. 17 shows a platform feature flow in which an individual or entity requests (e.g., applies for) a membership at a system of the present disclosure. The request for membership can then be reviewed and granted or approved. If approved, then the individual or entity is subscribed as a user of the system, and the system sources one or more deals to the user. The user can then post a deal opportunity and have the system route the opportunity to other users. The opportunity can be reviewed by the system and directed to select users (e.g., by email) or provided in personalized feeds of users. The user can also view an opportunity and contacts another user that is associate with the opportunity, or routes the opportunity to another user in a network of the user.

The system can allow a user to send a deal to those contacts of the user who are deemed to be interested in the deal. A user can be presented with an opportunity that is targeted to the user's current needs. The system can provide a user with a unified view of the user's contacts based on information relevant to the user's core business dealings.

The system can allow teams to filter shared contacts as well as route deal opportunities effectively within their internal and shared networks. The system can build a deal graph database of deal activity, and make the deal graph accessible to the user.

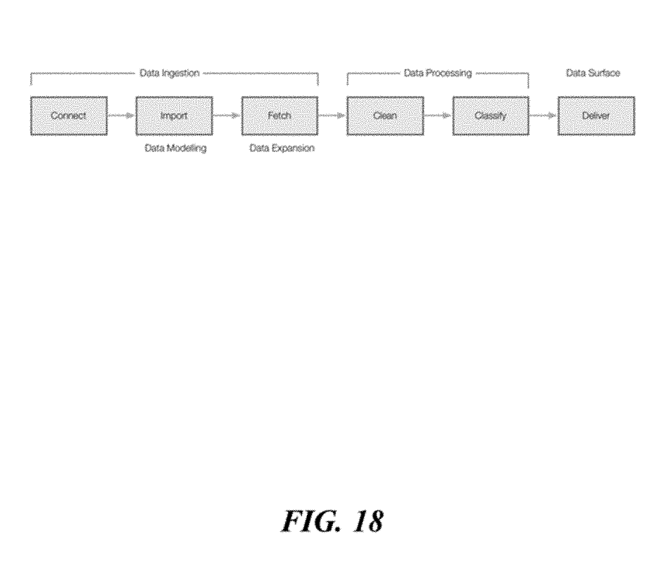

With reference to FIG. 18, the system can include a data ingestion module that includes sourcing, modelling and expanding an initial dataset of a user's contacts. A data processing module cleans up this data and then applies a set of classifiers to extract intelligence. These classifiers can be trained as the dataset grows. A data surface module exposes this to users via a user interface, such as a GUI or a web-based interface.

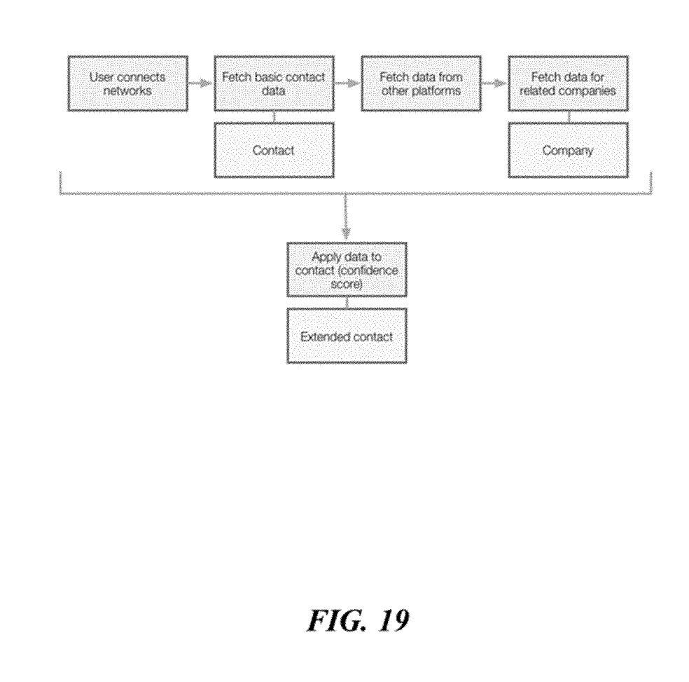

FIG. 19 shows a data ingestion work flow that can be implemented by the system. Data can be ingested by the system into a data repository. The system can identify extended contact data related to a person's professional deal activity by sourcing data from other sources and platforms and assessing its relevance to the deal making context. The system can also calculate a confidence match that the extended contact applies to the specific contact being processed. The extended contact data can include metadata.

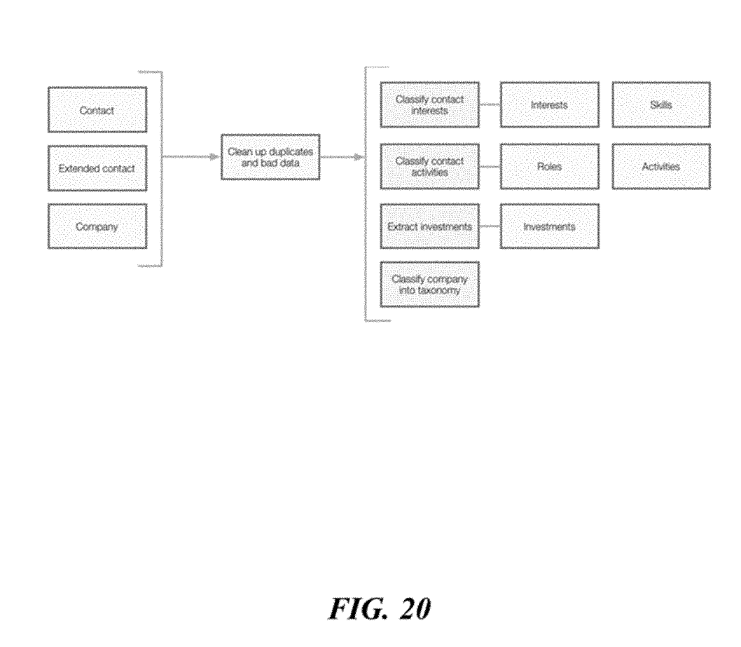

FIG. 20 shows a data processing work flow that can be implemented by the system. Under the workflow, contact data is ingested into the system from various sources into a data repository. The system can harmonize the contact data from the various sources into unified contact information. Duplicates and data that may not be useful to the system for identifying deals of potential interest to a user may be removed by the system. In some examples, the system can calculate a confidence match that one contact is a duplicate of another by examining the related data and performing fuzzy matching between specific high-signal metadata fields, including employment history and name rarity. The system can also calculate whether a contact is a person's professional or personal presence. The system can also employ various other functions, such as mapping taxonomies of interests, activities, roles, skills and industries based on data sourced about platform users' networks and specific to the business development context. These taxonomies can use reinforcement learning in an unsupervised context with some seed data, and is self-improving based on new incoming data. People and companies can be classified into these taxonomies with relevance and confidence scoring. This can include entity mapping as well as keyword extraction. Keywords and entities can be weighted based on their importance in deal making. Domain expertise for individuals within a specific taxonomy context can be modeled by the system.

In some cases, the system can identify and map investment and acquisition behavior, or specific models of other deal making behavior (e.g., celebrity endorsements and key partnerships). Additionally, the system can model specific attributes for contacts, including seniority, influence, decision-making power, partnership trends, thought leadership, and domain expertise. Such classifications can be used to expand classifications of entities related to them, e.g., related companies, co-investors and co-workers. The system can also model the proximity (or closeness) of ties and spread of influence within a business network in the context of a specific type of deal and specific industry, so as to calculate the affinity between contacts in various contexts.

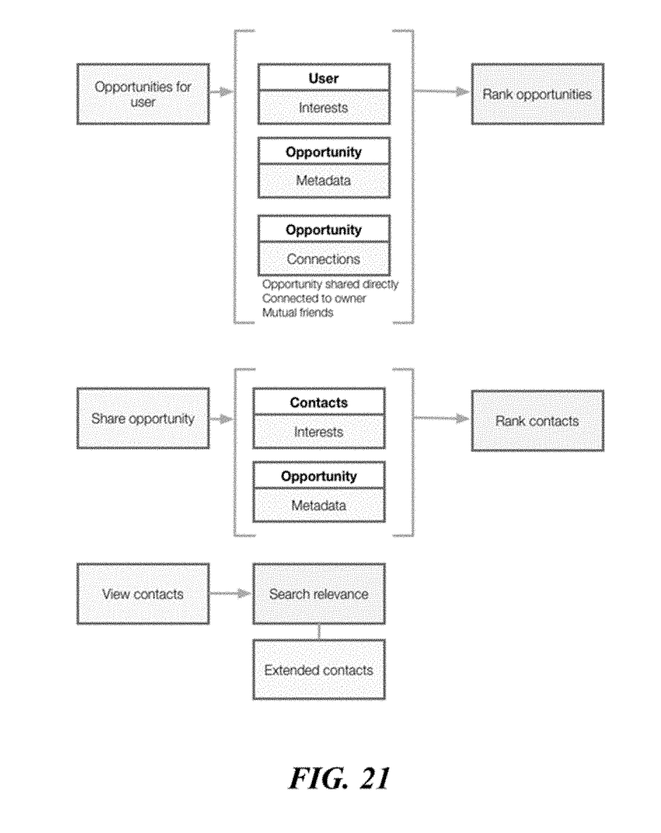

FIG. 21 shows a data surface that can be employed for use by the system. The data surface can enable the system to expose users to data intelligence. The data surface can be generated by the system by calculating the affinity between users and opportunities, for example by taking into account explicitly defined user interest, implied user interests, opportunity metadata and the social weight(s) between a user and another user (creator) that created a given deal opportunity. The system can rank an interest overlap score based on the user's interests and those extracted from the opportunity. The system can also calculate social weighting based on social ties, such as explicit sharing, whether the creator is a contact of the user, or whether they have mutual contacts. This can be expanded to use implicit signals, such as known previous co-user behavior (e.g., the creator and user both invested in the same company in the past).

The system can calculate the affinity between contacts and opportunities, which can enable the system to effectively predict the likelihood that a given contact would be interested in the deal opportunity, and ranking a user's contacts according to this likelihood. The user's contacts can be ranked in order of decreasing likelihood that they would be interested, with the most likely user listed towards the top of the list. This can focus on contact interests modelled and classified during the processing stage (e.g., implicitly), as opposed to opportunity metadata, such as metadata based on explicit categorization, extracted keywords, plus other affinity signals including the opportunity creator's educational and work history, professional interests, etc.

The system can allow a user to view contacts of the user in select locations with data pertinent to business role and industry of interest to the user. The system can provide high level data about the user's network, including its strength in different areas and suggested new contacts. A smart interface can be presented to the user, which varies the data shown per user depending on the user's specific queries and needs.

In some cases, contacts can be ranked within the context of a specific search, allowing the user to filter their contacts by different criteria. The affinities of contacts to individual search keywords can be stored and used calculate combined relevance scoring based on the search term in an on demand fashion.

### Probabilistic Entity-Phrase Association

Approaches discussed herein may be used to disambiguate named entities in web pages that are submitted to the API. By disambiguating named entities in web pages, search results that use information from the web pages may be more relevant. In examples, phrases may be assigned to people and companies in our corpus. In particular, the people and companies may be identified from content on the web and content that is found in various databases. A combination of these phrases may be used to rank people and companies higher up in search results, thereby disambiguating them from other people and companies in the corpus. Additionally, a large set of associations may be built up that can later be mined.

In examples, a series of webpages may be analyzed for associations between people and companies. Some of the webpages may be obtained by following URLs submitted to a backend system via a browser plugin. In examples, a browser plugin may generate a growing data layer that is based on types of users. This data may be relevant, as it may be generated by targeting specific users and it may be based on reactionary gathering. For instance, this form of data may be based on requesting particular documents that meet desired guidelines are retrieved.

Additionally, some webpages may be obtained by pointing a crawling subsystem at a dataset to be crawled. For example, a crawling subsystem may be based on data partnerships. Examples of data partnerships may include Angellist, Newscorp, Wealthengine, Glassdoor, Stripe, etc. The use of data partnerships may accelerate the growth and enrichment of a data layer. Additionally, another type of crawling that may be used is Active crawling. In particular, this type of crawling may allow data to be pulled down as it is posted. Examples of rich data sources that may be used for active crawling may include PR newswire, TechCrunch, and Bing. Through the use of active crawling, proactive crawling may be used to access information on these rich data sources. Additionally, predictive crawling of relevant sources may also be conducted based on new customers. As an example, an analysis may be conducted regarding which industries a customer sells to. Comprehensiveness of industry data may also be analyzed in the context of a people layer. Additionally, crawling may be conducted in a target area.

Initially, associations in the series of webpages may be vague. For example, a person may be identified as having been mentioned in the same article as another person or company. However, when supplemented with other levels of analysis, these associations may become more refined. Examples of sources for supplemental user information include Gmail, Linkedln, Facebook, and SalesForce. For example, a deep dive of supplemental information may be conducted using a user's Gmail account. For instance, contacts and email headers may be extracted from the user's Gmail account. This supplemental information may itself be contextualized based on a number of factors such as recency, frequency, relevance, and calendar integration.

Additionally, a deep dive of supplemental information may also be conducted using a user's SalesForce account. In particular, SalesForce may be a source of contact info for persons or companies. Additionally, SalesForce may be a source of Roles, Titles, Companies, and sales people who had engaging interactions with a contact. SalesForce may also be a good soruce for past sales history of a contact. Past sales history may include information such as who the person sells/sold to, what size of deals were conducted, a profile of the contact's ideal customer, a company that is an ideal company, and industry information. Further, a contact's company information may also be accessed on SalesForce. For example, the company information may include who the other sales people are at the company, including the contact information/email addresses of the other sales people.

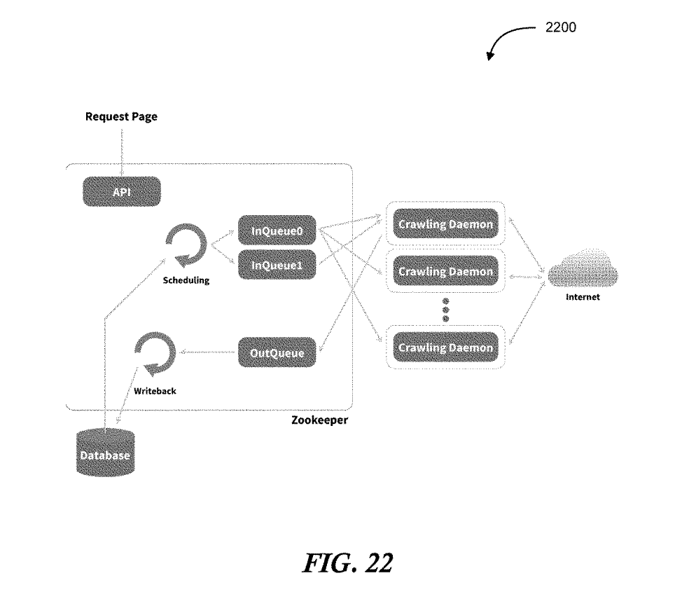

Technical aspects of acquiring data through crawling may include providing a distributed crawling structure. The distributed crawling structure may have a core piece of infrastructure. An example of a distributed crawling structure is seen in FIG. 22. In particular, FIG. 22 illustrates a distributed crawling structure 2200, in accordance with embodiments of the invention. The infrastructure of a distributed crawling network may allow multiple crawling components to work in parallel. Additionally, the technical process of acquiring data may make use of an intelligent crawler. In particular, the intelligent crawler may understand page structure to extract relevant content for analysis.

As provided herein, phrases may be added to the indexes to bring relevant people and companies up in search results. When a page on the Internet is obtained by the crawling subsystem, useful text may be extracted by a service that knows how to delineate the boundaries of articles, and the text may be analyzed. In some examples, names of people and companies identified in the text may already be in a system's corpus. Additionally, weights that reflect a confidence in the validity of an association may be assigned at the time the associations are created. In examples, the weights may be based on Lucene's implementation of term frequency-inverse document frequency (tf-idf). In particular, tf-idf may be used to illustrate how important a document is in a corpus. The tf-idf may be used as a weighing factor that increases proportionally to the number of times a word appears in the document, but is offset by the frequency of the word in the corpus. In this way, the tf-idf is able to adjust for the circumstance that some words, such as “the, a, and,” appear more frequently in general.

In examples, a typical phrase may be a series of words. In other examples, a typical phrase may not necessarily be a proper name or topic or even make sense to a human. For instance, a person's index record may have the phrases “seed funding,” “success stories,” and “ambitious uBeam working” associated with it. Based on the phrases in the person's index, the index entry associated with the person may be more likely to be brought up in search results when a page mentions any or all of these phrases.

Each person or company that is listed in a corpus may be referred to as a “named entity.” These named entities may go back to people and companies already in the corpus as identified by data that was from data sources like Google, AngelList and Crunchbase. When incorporating data from different sources to generate named entities people, a system may err on the side of treating two occurrences of the same name in different articles as two different people. In examples, a system may err on the side of treating a duplicate occurrence of a name as a stranger, initially treated as a completely different person from the entity having the duplicate name. However, as more information is gathered about the duplicate named entity, the duplicate named entity may be assessed against the known named entity to assess whether the duplicate named entity and the known named entity are the same. In some examples, once a confidence threshold is crossed, the occurrences of the duplicate named entity may be resolved to be included with the known named entity.

Additionally, a subsequent pass over the table of page-level entity-phrase associations may aggregate them and calculate a combined confidence score for an association that is a function of the confidence scores of the individual page-level associations. A quorum of two or possibly three pages may include the phrase before a named entity is updated with a new association.

When implementing a probabilistic entity-phrase association system, text that is returned from data sources may be tokenized. The tokenized text may then be used to query a search engine, such as Elasticsearch, to obtain contact and organization IDs. The contact and organization IDs may represent the named entities in the table of associations. In examples, these queries may be similar to queries from a plugin that is used. Additionally, these queries may place a corresponding load on ES, redis, etc.

For each page that is assessed, a cross product of characteristics, such as page id, entity id, and phrase, may be provided to postgres. Additionally, keywords may be updated for connection index entries from the aggregated associations when index connections are being rebuilt. Further, following an iterative process, the weightings at each level of the calculation may be tuned to the point where they are working together to produce good results.

In additional stages of implementing the system, the associations that are generated may be saved in postgres. However, this may be a short-term solution as the table of associations will gradually become large. In examples, for each page that is downloaded and analyzed, the number of rows may be the product of the number of entities that are recognized by the number of n-grams that are generated. In examples, there may be about 6000 associations per webpage. In additional examples, for 1,000,000 web pages crawled the number of associations may be on the order of six billion. Also, once the table grows beyond a certain point, the SQL aggregation query may become overly expensive.

In an alternative embodiment, the associations that are generated may be saved in an open source, non-relational, distributed database, such as HBase. A database as used with systems described herein may be specifically used to store information related to facilitating deals. In particular, databases may be used to exclusively store deal information. Additionally, in a structured ontology of relations between the entities, a taxonomy of subjects may be utilized. In other examples, a new source of data may be integrated for crawling. In examples, a crawling subsystem that goes beyond Diffbot may be used. Additionally, the new sources of data may be required to have adequate article boundary delineation.

Another source of data may be through the use of a stream, or possibly batch processing, to traverse the table of associations and aggregate them. In other examples, machine learning (e.g., topic models) may be used to detect new entities in the pages that are being crawled. In these examples, one or more people may be needed to handle the machine learning. In additional examples, a phrase association may be used to correlate data with the graph data coming in from the analysis of emails. Further, system characteristics may be included that may be used to deal with historical changes in the data.

As described in Examples below, information received from data sources may be processed and incorporated into layers. During processing names, companies, and keywords may be extracted from the data sources. Additionally, information may be validated as being added to be in association with the right people. In particular, information may be validated through multiple sources so as to ensure that the discovered data is accurate about the same person. Additionally, during data processing, connections may be made between entities. Information associated with the connection may include the taxonomy that serves as the basis of the connection.

Additionally, once the information layers have been generated, the information may come together to form a unique entity that encompasses information related to one particular entity, such as a person, company, family, or organization. In this way, the information that is provided may be formed into a particular entity.

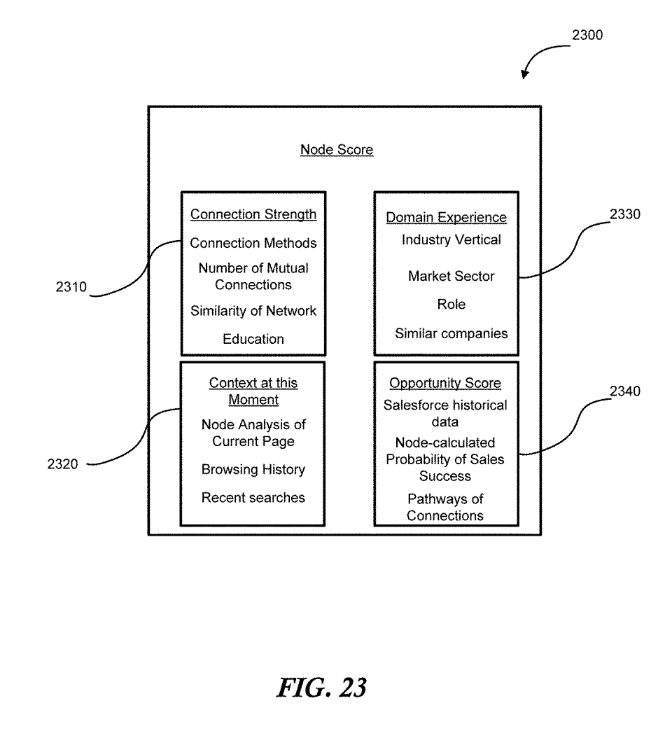

Once an entity has been generated based on the layered information, the entity may be evaluated based on its connection with other entities. This evaluation of connectedness may be referred to as a “node score.” FIG. 23 illustrates components of determining a node score 2300, in accordance with embodiments of the invention. In particular, FIG. 23 provides that a node score may be determined based on a number of factors such as connection strength 2310, present context 2320, domain experience 2330, opportunity score 2340, or a combination of these factors.

In a first example, a connection strength 2310 of an entity may be used to assess the entity's node score. In particular, a connection strength 2310 of an entity may be based on at least connection methods; number of mutual connections; similarity of network; education; or a combination of these factors. In a second example, a present context 2320 of an entity may be used to assess the entity's node score. In particular, a present context 2320 of an entity may be based on at least a node analysis of a current page; browsing history; recent searches; or a combination of these factors.

In a third example, a domain experience 2330 of an entity may be used to assess the entity's node score. In particular, a domain experience 2330 of an entity may be based on at least industry vertical; market sector; role; similar companies; or a combination of these factors. In a fourth example, an opportunity score 2340 of an entity may be used to assess the entity's node score. In particular, an opportunity score 2340 of an entity may be based on at least SalesForce historical data; node-calculated probability of sales success; pathways of connections; or a combination of these factors.

In additional examples, a node score may be generated based on a combination of connection strength, present context, domain experience, and opportunity score. In particular, a node score may weigh each of these factors and evaluate connectedness of an entity based on these factors. Additionally, the node score of an entity may be used to assess and match other entities, such as individuals and companies. In assessing entities, such as individuals, a connection class may be assigned. The assignment of connection classes allows a simple way to assess relevancy of an entity in a given context. Additionally, in matching entities based on their node scorer, an assessment may consider similarity to whom an entity has sold to in the past. Additionally, an assessed node score may allow another entity to check to see if another entity has sold to them in the past.

A node score that is determined for an entity may be used for lead routing to entities that are particularly connected to another entity. In particular, a node score may be used to indicate how how two entities are related, how an entity is related to the rest of the world, and who an individual may want to additionally know based on other entity connections. A node score may also be used as a factor in prioritizing one's activities for a day. In particular, a node score may be used to rank a list of people or entities to talk to in a day. The node score may be useful in determining how an enterprise is connected to a person.

Methods discussed herein may also be used to optimize a funnel of deal success based on analyzing sales teams and sales structure of successful deal. In particular, based on successful deals, an optimized sale structure may be determined for a particular entity. Additionally, sales funnels may be generated and/or modified based on past behavior between entities. In examples, people who have similarities may be recommended. In particular, people who have similarities may be recommended based on three different variables, such as a class of a person or a node score of a person.

In an example of a flow that may incorporate flow considerations, a representative may initially close a deal. Additionally, a node component may look at a person and look at a company. The node may also look into a node layer and find a company that has the same industry, size, revenue, employees, etc. Additionally, the node may look for an employee that matches the employee that was passed from the closed deal who has the closes connection to a particular sales representative.

### Node Sales Prediction Engine

A node sales prediction engine may be used with information provided herein so as to allow customers to interact with desired or predetermined contacts. In some examples, the node sales prediction engine may interact with SalesForce to access desired information. In an example, a field may be put on each lead and contact which tells an entity which sales team member has a highest node score with a person. In another example, a field may be put on each lead and contact which tells an entity what the connection score is between this person and the sales team with the highest node score. Additionally, a field may be put on each lead and contact which is the lead/contact owner's node score with person. In other examples, a field may be put on each lead and contact to track if it's a node generated lead. Further, a field may be put on each lead and contact to track if a sales team with a highest node score is lead/contact owner.

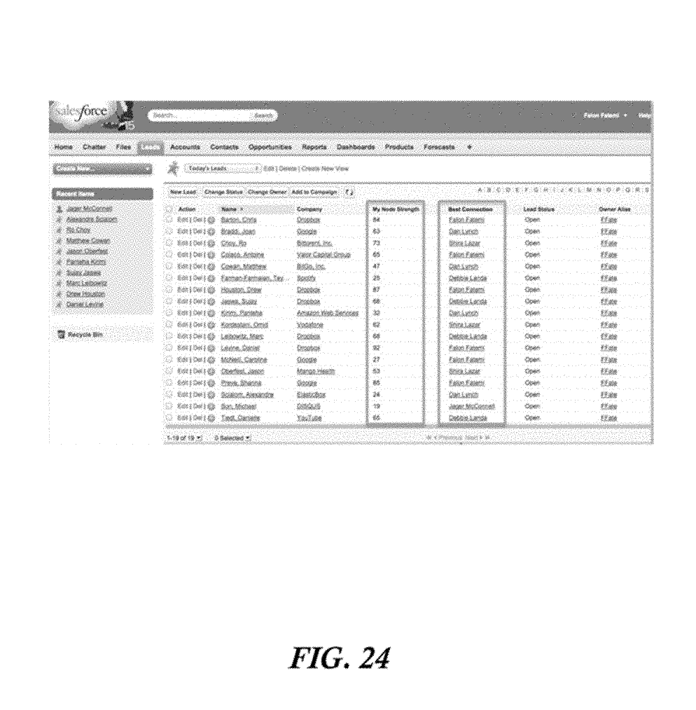

Additionally, information may also be provided on whether the sales team with the highest node score is utilizing lead routing. Node also builds tools which may connect to a sales information entity, such as SalesForce.org, using published SalesForce APIs to check for newly created/updated leads and contacts, and to create new leads. In particular, a node sales prediction engine may be integrated with a contact relationship management (CRM) system. In an example, FIG. 24 illustrates integrating a node sales predication engine into a contact relationships management system, in accordance with embodiments of the invention. In examples, the CRM may be SalesForce. As seen in FIG. 24, a node ranking and a best connection indicator are provided as columns, respectively, that are integrated into SalesForce.

### EXAMPLES

Following are some examples that illustrate the general approach being described herein.

### Example 1

### Storing Associations

1. Look for existing named entities in page. This may be done with respect to Michael I. Jordan, as provided below:
Michael I. Jordan is the Pehong Chen Distinguished Professor in the Department of Electrical Engineering and Computer Science and the Department of Statistics at the University of California, Berkeley.
   His research in recent years has focused on Bayesian nonparametric analysis, probabilistic graphical models, spectral methods, kernel machines and applications to problems in signal processing, statistical genetics, computational biology, information retrieval and natural language processing. Prof. Jordan was elected a member of the National Academy of Sciences (NAS) in 2010, of the National Academy of Engineering (NAE) in 2010, and of the American Academy of Arts and Sciences in 2011. He is a Fellow of the American Association for the Advancement of Science (AAAS). He has been named a Neyman Lecturer and a Medallion Lecturer by Institute of Mathematical Statistics (IMS). He is a Fellow of the IMS, a Fellow of the IEEE, a Fellow of the AAAI, and a Fellow of the ASA.

Accordingly, the phrase in bold is one that matches one or more existing named entities in the corpus. The phrases in italics are ones that are associated with a high degree of confidence as being associated with one of those named entities, Michael Jordan, a professor of machine learning at UC Berkeley. The phrases are derived from information that is brought in from a trusted source (e.g., AngelList, CrunchBase or Google).
2. There are two “Michael Jordans” already in our corpus and many that are not (including the basketball player and the actor). The likelihood that either of the known Michael Jordans is the one mentioned in the page is calculated:
   Michael Jordan (machine learning professor, id 13579) has four keyword matches. Some of the keywords are not found very often in the corpus, so they are given a strong weighting; score: 0.8.
   Michael Jordan (fitness trainer, id 24680) has zero keyword matches. This could be because the page doesn't provide much identifying information, so the Michael Jordan having this id 24680 is not excluded as a possibility; score: 0.05.
3. We add a cross product of named entity and phrase pairs for the page to a large table of associations. Here “13579” refers to Michael Jordan, the professor, and “24680” refers to Michael Jordan, the fitness trainer.

| Page | Entity | Phrase | Score |
|---|---|---|---|
| 90e639a | id 13579 | National Academy | 0.8 |
| 90e639a | id 13579 | IMS Fellow | 0.8 |
| 90e639a | id 13579 | spectral methods | 0.8 |
| 90e639a | id 13579 | focused Bayesian | 0.8 |
| | | nonparametric | |
| 90e639a | id 13579 | applications | 0.8 |
| | | problems signal | |
| 90e639a | id 13579 | recent years focused | 0.8 |
| 90e639a | id 13579 | Neyman Lecturer | 0.8 |
| 90e639a | id 13579 | Medallion Lecturer | 0.8 |
| . . . | | | |
| 90e639a | id 24680 | National Academy | 0.05 |
| 90e639a | id 24680 | IMS Fellow | 0.05 |
| 90e639a | id 24680 | spectral methods | 0.05 |
| 90e639a | id 24680 | focused Bayesian | 0.05 |
| | | nonparametric | |
| 90e639a | id 24680 | applications | 0.05 |
| | | problems signal | |
| . . . | | | |

There is now a strong association of “Neyman Lecturer” and “Medallion Lecturer” with the machine learning professor and a weak one with the fitness trainer.

### Example 2

### Adding an Entity-Phrase Association to an Indexed Connection Entry for Matching in Future Search Results

1. Aggregate over the table of associations, looking for ones that are mentioned across some minimum number of pages (e.g., three distinct pages).

| Page | Entity | Phrase | Score |
|---|---|---|---|
| 6b3cc08 | id 13579 | IMS Fellow | 0.56 |
| 90e639a | id 13579 | IMS Fellow | 0.8 |
| 2f0c0d6 | id 13579 | IMS Fellow | 0.26 |
| e639a8f | id 13579 | IMS Fellow | 0.005 |
| . . . | | | |

Here there are four instances in which an association has been made between the phrase “IMS Fellow” and the Michael Jordan, the professor. Two were significant ones and one was a very weak one. Since the phrase has been seen in a minimum number of articles, it will be associated with his connection entry. The weight for the phrase will be a function of the individual scores (0.56, 0.8, 0.26, and 0.005).

2. Calculate a confidence score for the generalized association that takes into account the scores of the individual page-level associations:
combinedScore(0.56, 0.8, 0.26, 0.005)=0.65
3. The phrase “IMS Fellow” is added to the index entry for Michael Jordan (machine learning professor, id 13579). In the future, a page that mentions “IMS Fellow” and “Michael Jordan” is more likely to bring up the machine learning professor.

### Example 3

### Handling a Page that Mentions Two Michael Jordans

There is a risk the associations two Michael Jordans may be confused if the two Michael Jordans are mentioned on the same page; e.g., a disambiguating system may associate fitness training with the Michael Jordan that is a professor and the disambiguating system may associated machine learning with the Michael Jordan that is a fitness trainer.

Assume some time passes and two more Michael Jordans are added to the corpus—the basketball player (id 123123) and the actor (id 456456).
1. Look for existing names in the page.
   Actor Michael B. Jordan says it isn't easy sharing names with the famous basketball player.
   Last night, Michael Jordan appeared on “Jimmy Kimmel Live.”
   No, not THAT Michael Jordan.
   Actor Michael B. Jordan.
   You probably recognize the 26-year-old actor from his roles on “The Wire,” “Friday Night Lights,” and last year's superhero flick “Chronicle.” . . .

As before, the phrases in bold are recognized names, and the phrases in italics are terms associated with existing connections.
2. We calculate the likelihood that any of the Michael Jordans listed in the corpus are in the text.
   Michael Jordan (machine learning professor, id 13579) has zero keyword matches; score: 0.05.
   Michael Jordan (fitness trainer, id 24680) has zero keyword matches; score: 0.05.
   Michael Jordan (basketball player, id 123123) has one strong keyword match. Score: 0.50.
   Michael Jordan (actor, id 456456) has two strong keyword matches; score: 0.70.
   Because there are two named entities with identical names that have been identified as likely matches, there's a good chance the associations between the two may be confused, so any associations for any of the Michael Jordans that are recognized from this page are not saved. In contrast, associations for other named entities that are recognized from this page may be saved.

### Example 4

### Node Intelligent Lead Routers

When a comma separated values list of leads get uploaded to SalesForce using SalesForce's standard import process, an integration alert may indicate to Node servers that new leads created. In response, the Node servers may pull necessary information, such as a name, email, and current owner, from newly created leads to run analysis. In particular, Node may run analysis on new records. For example, Node may check connection strength of each sales person at organization against each lead that is uploaded. Additionally, on the lead record, Node may insert which sales team member has highest node score into a “Best Sales Person” lead. Also on a lead record, Node may insert the Node connection score of the sales team with the highest node score and may insert this lead into a “Best Sales Score” lead. Node may also insert the Node connection score of the lead owner onto the lead record into an “Owner Score” lead. Once fields have been updated, SalesForce lead routing rules may be triggered and may reassign a lead to person having a designated “Best Sales Person” lead. In examples, some companies may not have the “Best Sales Person” lead option. Further, Node may be notified that the lead has been updated. In examples, a lead may be updated in the event of a change of owner. In additional examples, Node may update a lead record so that an “Owner Score” and a “Best Sales Score” are equivalent when both leads refer to the same person. Additionally, the Node may update a lead “Owner Node Match.” Further, the best sales rep for this lead may have the lead assigned to them may be able to track the deal, such as by using a “Best Sales Person” lead. In examples, the same process may happen with the other 1000 leads imported at same time for a tradeshow.

### Example 5

### Node Predictive Lead Generator

Node servers may nightly check to see if any opportunities moved to closed have won a sale. When found, Node servers may extract the people associated with the won opportunity for analysis (pulling out name, email, role on opportunity, company, title, and contact owner). Additionally, Node may run analysis on extracted people, understanding strongest keywords, companies, roles, etc. Once a profile of the people on won deals (btw we'd do this historically when someone starts using Node—but then we'd do this just when new opportunities are created) has been calculated we'll then generate the closest match of similar people (based on keywords, similar companies, role, number of connections, etc).

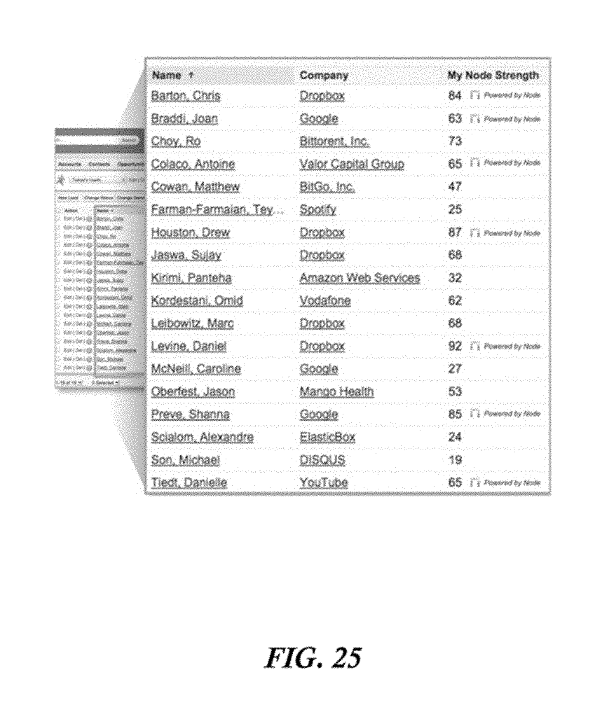

With that list, we'll remove any that Node has suggested in the past; we'll remove any that are at companies that have had opportunities in the past in the SalesForce org; and we'll then sort the leads based on the connection score of the original contact owner. Additionally, Node may then inserts the X number of leads that match that profile into SalesForce and assign the contact owner the new leads. Node may also check the “Node Generated” field. The Node may then execute the analysis and updates the lead based on the Node Intelligent Lead Router, as described above. An example of generated leads is illustrated in FIG. 25. In particular, FIG. 25 illustrates a display of leads generated from a predictive lead generator, in accordance with embodiments of the invention.

### Example 6

### Node Automatic Researcher

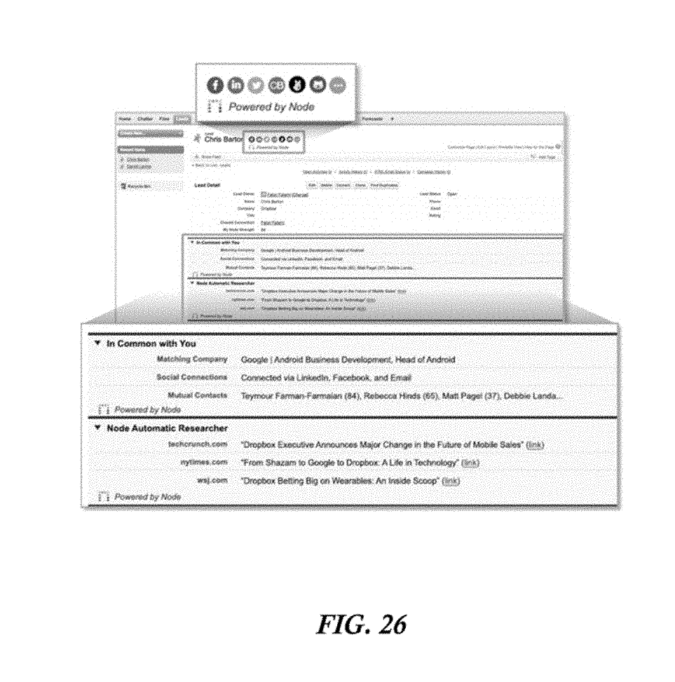

As Node crawls the web building profiles of people, Node may associate web pages and articles with individuals to build the universal profile. When Node finds a relevant URL to a person in a user's SalesForce organization, Node may put the URL into a section of the Contact/Lead page. Additionally, a sales person may easily read through the pages (sorted by strength to person) that are discovered using the automatic researcher. An example of a display of an automatic researcher is found in FIG. 26. In particular, FIG. 26 illustrates a display of an automatic researcher, in accordance with embodiments of the invention.

### Example 7

### Node Sales Analytics

Node may have a dashboard in SalesForce which displays the following data: Average Sales Person win rates where a lead “Owner Node Match”=True vs False over time; Average size of deal of a lead “Owner Node Match”=True vs False over time; Average deal volume of a lead “Owner Node Match”=True vs False over time; Total $ from Opportunities Won which had a person with a lead “Node Generated” field checked involved over time; and Sales Reps with average best connection scores to ideal sales leads. The dashboard may also display the following data: a “Node Generated” lead count assigned by each sales rep; Top keywords for contacts associated with close won; Number of potential leads in Node People Layer based on ideal sales profile; Number of potential new sales people that match ideal sales person profile in Node People Layer; and Top identified companies that are not currently customers, etc.

### Example 8

### Enterprise Plugin

An enterprise plugin may work in the same way as the consumer plugin with a few differences. In particular, the enterprise plugin may indicate if the person already exists within SalesForce as a lead/contact. If the person is not found in SalesForce, the plugin may allow you to push the lead into SalesForce. Additionally, the plugin may allow you to pin the page you're on to the lead/contact. The plugin may also surface who on your sales team is best connected with the person discovered.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for facilitating deals, comprising:
(a) accessing one or more network sources of a user and identifying content in said one or more network sources, which content comprises textual, graphical and/or audio information;
(b) using a computer processor that is programmed to identify industry segments, user interests and/or roles from content, searching said content for textual, graphical and/or audio information that are indicative of one or more industry segments, user interests and/or user roles;
(c) storing said one or more industry segments, user interests and/or user roles in a memory location coupled to said computer processor;
(d) conducting a search of a repository of deals to identify one or more deals based at least in part on a match between (i) said one or more industry segments, user interests and/or user roles from said memory location and (ii) industry segments, user interests and/or user roles associated with said deals; and
(e) presenting said one or more deals identified in (d) to said user.

2-38. (canceled)
